(19) United States
(12) Patent Application Publication
(10) Pub. No.: US 2023/0375290 A1
(43) Pub. Date: Nov. 23, 2023

(54) LAMINATE FOR RADIATIVE COOLING AND PREPARING METHOD THEREOF

(71) Applicants: HYUNDAI MOTOR COMPANY, Seoul (KR); KIA CORPORATION, Seoul (KR)

(72) Inventor: Min Jae Lee, Seongnam-si (KR)

(73) Assignees: HYUNDAI MOTOR COMPANY, Seoul (KR); KIA CORPORATION, Seoul (KR)

(21) Appl. No.: 17/897,407

(22) Filed: Aug. 29, 2022

(30) Foreign Application Priority Data
May 20, 2022 (KR) 10-2022-0062110

(51) Int. Cl. F28F 13/18

(52) U.S. Cl. CPC F28F 13/18; F28F 2245/06

(57) ABSTRACT

A laminate for radiative cooling includes a porous base layer including a visible-ray reflective polymer and having nano-sized pores formed in the visible-ray reflective polymer, and a coating layer formed on one face of the porous base layer and including an infrared-ray emissive polymer.

### CROSS-REFERENCE TO RELATED APPLICATION

This application claims the benefit of priority to Korean Patent Application No. 10-2022-0062110, filed in the Korean Intellectual Property Office on May 20, 2022, the entire contents of which are incorporated herein by reference.

### TECHNICAL FIELD

The present disclosure relates to a laminate for radiative cooling having excellent infrared-ray emission ability and ultraviolet-ray reflection ability, and a preparing method thereof.

### BACKGROUND

The statements in this section merely provide background information related to the present disclosure and may not constitute prior art.

In general, consumption of energy is essential for cooling. For example, general-purpose cooling devices such as refrigerators and air conditioners perform cooling by using energy to compress refrigerant and then using absorption of heat generated when the compressed refrigerant is expanded. However, radiative cooling refers to a technology that achieves cooling without consumption of the energy unlike the general-purpose cooling devices. In order to improve the radiative cooling efficiency, it is important to well control absorption ability, reflection ability and radiative ability of light of each of wavelength bands. A substantial amount of heat is generated from incident sunlight. The sunlight is divided into ultraviolet-ray (UV), visible-ray, and infrared-ray. When an object reflects the light of each of the wavelength bands, the object may block inflow of heat through sunlight. For example, during the day when the sunlight is shining, a black vehicle that absorbs light well has a relatively fast internal temperature rise, while a white vehicle that does not absorb light and reflects light therefrom well has a relatively slow internal temperature rise.

A material for the radiative cooling may include various materials such as a polymer, a multilayer thin film of inorganic material or ceramic material, a radiative cooling element including a metal reflective layer, and a paint including a white pigment. The polymer material may have a high absorption (emissivity) of infrared-ray but a short lifespan as it is easily deteriorated by UV rays and moisture when being left outdoors due to nature of the material. Regarding the multi-layer thin film, in order to increase emissivity of infrared-ray thereof, the number of layers are increased. Thus, absorption of sunlight thereof is increased such that it is difficult for the multi-layer thin film to achieve high-efficiency radiative cooling performance. Further, the material including the metal reflective layer may not be applied in real life due to poor long-term stability due to oxidation of the metal, and a cost thereof. The metal material exhibits specular reflection, thereby causing eye fatigue and light blur. The paint containing the white pigment may not be composed of a material with a high extinction coefficient, and thus lacks infrared-ray emissivity and ultraviolet-ray reflectivity, thereby having insufficient radiative cooling ability.

In an alternative to this problem, Korean Patent No. 2154072 discloses a coolant capable of color rendering in radiative cooling, the coolant including a first material that emits infrared-ray to cause radiative cooling, and a second material that absorbs light in a visible-ray region and converts a wavelength thereof and emits light of the converted wavelength. However, the coolant in which the second material such as a dye or a semiconductor material is mixed with the first material that emits infrared-rays under electromagnetic resonance lacks radiative cooling ability due to low ultraviolet-ray reflectance.

Therefore, we have found that it is desired to research and develop a material having excellent flexibility and excellent infrared-ray emission ability and ultraviolet-ray reflection ability and thus radiative cooling ability.

### SUMMARY

An aspect of the present disclosure provides a laminate and methods for preparing such a laminate having excellent flexibility, excellent infrared-ray emission ability, and excellent ultraviolet-ray reflection ability, and thus excellent radiative cooling ability.

The technical problems to be solved by the present disclosure are not limited to the aforementioned problems, and any other technical problems not mentioned herein are understood from the following description by those having ordinary skill in the art to which the present disclosure pertains.

According to a first aspect of the present disclosure, a laminate for radiative cooling includes a porous base layer including a visible-ray reflective polymer and having nano-sized pores formed in the visible-ray reflective polymer, and a coating layer formed on one face of the porous base layer and including an infrared-ray emissive polymer.

According to a second aspect of the present disclosure, a radiative cooling element includes the laminate for radiative cooling.

According to a third aspect of the present disclosure, a vehicle includes the radiative cooling element.

According to a fourth aspect of the present disclosure, a method for preparing a laminate for radiative cooling includes applying and curing a raw material composition containing a visible-ray reflective polymer and pore-forming inorganic particles to form a cured film; etching and removing the pore-forming inorganic particles from the cured film to obtain a porous base layer in which pores derived from the pore-forming inorganic particles are formed; and forming a coating layer including an infrared-ray emissive polymer on one face of the porous base layer.

### BRIEF DESCRIPTION OF THE DRAWINGS

The above and other objects, features, and advantages of the present disclosure are more apparent from the following detailed description taken in conjunction with the accompanying drawings:

FIG. 1 is a cross-sectional view of a laminate for radiative cooling according to an embodiment of the present disclosure;

FIG. 2 is an infrared-ray emission ability measurement result in an embodiment of the present disclosure; and

FIG. 3 is a measurement result of infrared-ray emission ability of a coating layer according to an embodiment of the present disclosure.

The drawings described herein are for illustration purposes only and are not intended to limit the scope of the present disclosure in any way.

### DETAILED DESCRIPTION

The terminology used herein is for the purpose of describing particular embodiments only and is not intended to limit the present disclosure. As used herein, the singular constitutes “a” and “an” are intended to include the plural constitutes as well, unless the context clearly indicates otherwise. The terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof.

When a component, device, element, or the like of the present disclosure is described as having a purpose or performing an operation, function, or the like, the component, device, or element should be considered herein as being “configured to” meet that purpose or to perform that operation or function.

In addition, when a first element or layer is referred to as being present “on” or “beneath” a second element or layer, the first element may be disposed directly on or beneath the second element or may be disposed indirectly on or beneath the second element with a third element or layer being disposed between the first and second elements or layers.

### Laminate for Radiative Cooling

A laminate for radiative cooling according to the present disclosure includes a porous base layer having nano-sized pores therein and a coating layer formed on one face of the porous base layer.

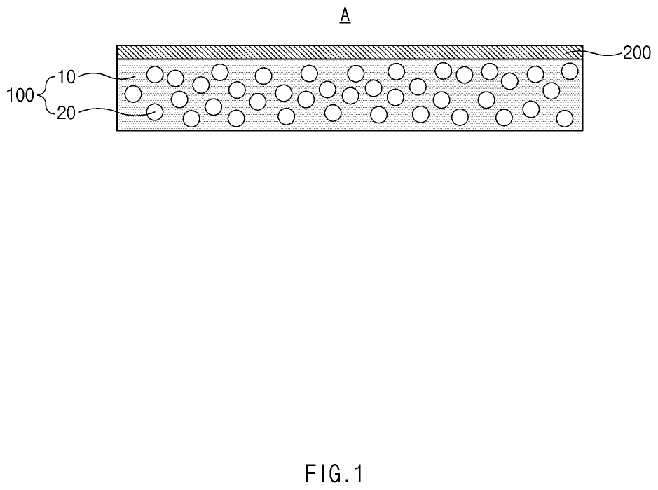

Referring to FIG. 1, a laminate (A) for radiative cooling according to the present disclosure may include a porous base layer 100 and a coating layer 200 formed on one face of the porous base layer 100.

### Porous Base Layer

The porous base layer is configured to emit heat via reflection of ultraviolet-ray rays and visible-rays.

The porous base layer has spherical pores therein derived from pore-forming inorganic particles. Specifically, the porous base layer is very suitable as a material for radiative cooling because of its high reflectance of ultraviolet-ray and visible-rays due to presence of randomly distributed nano-sized pores therein.

Referring to FIG. 1, the porous base layer 100 may include a visible-ray reflective polymer 10 and nano-sized pores 20 therein.

The visible-ray reflective polymer may include, for example, a fluorine-based polymer. Specifically, the visible-ray reflective polymer may include a copolymer including a hydrofluoroolefin (HFO)-derived repeating unit and a perfluoroolefin (PFO)-derived repeating unit.

The hydrofluoroolefin (HFO)-derived repeating unit is an organic compound composed of hydrogen (H), fluorine (F) and carbon (C), and refers to a partially hydrogenated fluorinated olefin-derived repeating unit. For example, the hydrofluoroolefin-derived repeating unit may be an olefin-derived repeating unit represented by a chemical formula CX₂═CX—R, wherein X independently represents hydrogen or fluorine, and R represents hydrogen, fluorine, or a C₁ to C₈ alkyl group). Specifically, the hydrofluoroolefin-derived repeating unit may be a vinylidene fluoride (VDF, CF₂═CH₂)-derived repeating unit.

The perfluoroolefin (PFO)-derived repeating unit is an organic compound composed of hydrogen (H), fluorine (F) and carbon (C), and refers to a perfluoroolefin-derived repeating unit. For example, the perfluoroolefin (PFO)-derived repeating unit may be an olefin-derived repeating unit represented by a chemical formula CF₂═CF—R_{f} (where R_{f} represents a C₁ to C₈ perfluoroalkyl group). Specifically, the perfluoroolefin (PFO)-derived repeating unit may be a tetrafluoroethylene (TFE) or hexafluoropropylene (HFP)-derived repeating unit.

Specifically, the fluorine-based polymer may include poly(vinylidene fluoride-hexafluoropropylene).

The visible-ray reflective polymer may have an average molecular weight (Mw) in a range of 350,000 to 1,300,000 g/mol, or in a range of 500,000 to 1,000,000 g/mol. When the weight average molecular weight of the visible-ray reflective polymer is within one of the above ranges, infrared-ray emission performance of the laminate is improved.

Each of the pores may have an average diameter in a range of 80 to 600 nm, 100 to 500 nm, 100 to 200 nm, 400 to 600 nm, or 450 to 500 nm. When the average diameter of each of the pores is within one of the above ranges, scattering effect of ultraviolet-ray and visible-ray thereof is improved, and infrared-ray emission ability thereof is improved. To the contrary, when the average diameter of the pores is smaller than the above range (e.g., less than 80 nm), the scattering effect of ultraviolet-ray rays and visible-rays, and the infrared-ray reflection effect may be insufficient. In this regard, the average diameter of each of the pores may be an average value of diameters of pores contained within 1 cm² of a SEM cross section.

The porous base layer may have a porosity in a range of 20 to 80%, 20 to 40%, 40 to 60%, 50 to 80% or 60 to 70%. When the porosity of the porous base layer is within one of the above ranges, the base layer is mechanically stable and has excellent radiative cooling performance. To the contrary, when the porosity of the porous base layer is smaller than the above range (e.g., less than 20%), the laminate may not realize target radiative cooling performance. When the porosity thereof exceeds the above range (e.g., greater than 80%), the laminate may not be mechanically stable. In this regard, the porosity is a result of calculating an area of pores contained in 1 cm² of the SEM cross section in a percentage manner and may be an area %.

Further, the porous base layer may have an average thickness in a range of 600 to 900 micrometers (μm) or 700 to 800 μm. When the average thickness of the porous base layer is smaller than one of the above ranges, there is a problem that the laminate cannot realize the target radiative cooling performance.

### Coating Layer

The coating layer serves to radiate heat via infrared-ray radiation.

Referring to FIG. 1, the coating layer 200 is formed on the porous base layer 100. In this regard, the coating layer includes infrared-ray emissive polymer and may not contain pores therein.

The infrared-ray emissive polymer may include a fluorine-based polymer, a urethane-based polymer, a vinyl-based polymer, an ester-based polymer, an amide-based polymer, or a combination thereof.

Specifically, the infrared-ray emissive polymer may include a copolymer including a hydrofluoroolefin (HFO)-derived repeating unit and a perfluoroolefin (PFO)-derived repeating unit. That is, the infrared-ray emissive polymer may include the same material as that of the visible-ray reflective polymer.

For example, the infrared-ray emissive polymer may include poly(vinylidene fluoride-hexafluoropropylene) (PVDF-HFP), polyethylene terephthalate (PET), polycarbonate urethane (PCU), polyvinyl chloride (PVC), nylon, polytetrafluoroethylene (PTFE), or a combination thereof.

The coating layer may have an average thickness in a range of 50 to 500 μm, 50 to 500 μm, 50 to 300 μm, 50 to 200 μm, or 100 to 200 μm. When the average thickness of the coating layer is smaller than the above range (e.g., less than 50 μm), there is a problem that the laminate cannot realize the target radiative cooling performance.

The laminate for radiative cooling may have an average reflectance of light in a wavelength of 200 to 400 nm in a range of 70 to 90%, 70 to 80%, or 80 to 90%. Further, the laminate for radiative cooling may have a reflectance of light in a wavelength of 400 to 700 nm in a range of 70 to 95%, 70 to 80%, 80 to 95%, or 85 to 95%. Therefore, the laminate for the radiative cooling is very suitable as a material for radiative cooling because it has excellent reflectance of ultraviolet-ray rays with a wavelength of 200 to 400 nm and visible-ray with a wavelength of 400 to 700 nm.

Further, the laminate for the radiative cooling may have excellent radiative cooling ability as it has excellent emissivity in a wavelength of 8 to 12 μm as an atmospheric window. For this reason, the laminate for the radiative cooling has excellent radiative cooling effect by efficiently radiating the wavelength within the atmospheric window, and thus may be applied to significantly lower an internal temperature of a car.

As described above, the laminate for radiative cooling according to the present disclosure has excellent flexibility and has excellent infrared-ray emission ability and ultraviolet-ray reflection ability, and thus has very excellent radiative cooling ability. Therefore, the laminate for the radiative cooling may be suitably used as a material in various fields that require a material with excellent radiative cooling ability, such as vehicles.

### Radiative Cooling Element

A radiative cooling element in accordance with the present disclosure include the laminate for radiative cooling.

As described above, the radiative cooling element includes the laminate for radiative cooling that has excellent ultraviolet-ray and visible-ray reflection ability and thus excellent infrared-ray emission ability. Thus, the radiative cooling element may be used in various fields, such as vehicles, where an element with excellent radiative cooling capability is required.

### Vehicle

A vehicle in accordance with the present disclosure includes the radiative cooling element. Thus, the vehicle is able to save cooling energy in summer and is excellent in energy efficiency.

### Method of Preparing Laminate for Radiative Cooling

A method of preparing a laminate for radiative cooling according to the present disclosure includes forming a cured film; obtaining a porous base layer from a cured film; and forming a coating layer on one face of the porous base layer.

### Step of Forming a Cured Film

In this step, a cured film is formed by applying a raw material composition containing a visible-ray reflective polymer and pore-forming inorganic particles.

The visible-ray reflective polymer plays a role in emitting heat via reflection of ultraviolet-ray rays and visible-rays. In this regard, the visible-ray reflective polymer may include, for example, a fluorine-based polymer. The visible-ray reflective polymer is the same as that as described above with reference to the porous base layer of the laminate for the radiative cooling.

The pore-forming inorganic particles may be easily removed in an etching process, and thus may play a role in forming the pores in the porous base layer. In this regard, a type of the pore-forming inorganic particles may not be particularly limited as long as the pore-forming inorganic particles are ordinary inorganic materials that may be easily removed in the etching process. For example, the pore-forming inorganic particle may include silicon dioxide (SiO₂), titanium dioxide (TiO₂), aluminum oxide (Al₂O₃), aluminum (Al), silicon nitride (Si₃N₄), or combinations thereof. Specifically, the pore-forming inorganic particle may be made of SiO₂.

Further, each of the pore-forming inorganic particles may have an average diameter in a range of 100 to 5,000 nm, 400 to 4,000 nm, 400 to 600 nm, or 450 to 550 nm. When the average diameter of each of the pore-forming inorganic particles is within one of the above ranges, the laminate may effectively reflect visible-ray incident onto the laminate therefrom. To the contrary, when the average diameter of each of the pore-forming inorganic particles is smaller than the above range (e.g., less than 100 nm), the visible-ray reflectance of the porous base layer may be lowered. When the average diameter thereof exceeds the above range (e.g., greater than 5,000 nm), the mechanical properties of the porous base layer are weakened.

A shape of each of the pore-forming inorganic particles may be, for example, spherical. Thus, a shape of each of the pores in the porous base layer may be spherical.

The raw material composition includes the visible-ray reflective polymer and the pore-forming inorganic particles. In this regard, the raw material composition includes the visible-ray reflective polymer and the pore-forming inorganic particles in a mass ratio in a range of 1:0.8 to 1:5, a mass ratio in a range of 1:0.9 to 1:2.5, or a mass ratio in a range of 1:1 to 1:2 When the mass ratio of the visible-ray reflective polymer and the pore-forming inorganic particles is within one of the above ranges, the porous base layer is mechanically stable and has excellent radiative cooling performance. To the contrary, when the mass ratio of the visible-ray reflective polymer and the pore-forming inorganic particles is smaller than the above range (e.g., less than 1:0.8), the porous base layer cannot realize the target radiative cooling performance. When the ratio exceeds the above range (e.g., greater than 1:5), the porous base layer is not mechanically stable.

Further, the raw material composition may further include a solvent. In this regard, the solvent contains the visible-ray reflective polymer and the pore-forming inorganic particles in a dispersed manner therein so that the visible-ray reflective polymer and the pore-forming inorganic particles are uniformly applied.

The solvent may be used without any particular limitation as long as it may uniformly disperse the visible-ray reflective polymer and the inorganic particles therein. The solvent may include dimethylformamide, diethylene glycol, dimethyl sulfoxide, N-methylpyrrolidone, butyrolactone, ethylene glycol monoethyl ether, dimethyl acetamide, hexamethyl phosphate triamide, or a combination thereof. Specifically, the solvent may be dimethylformamide (DMF).

Further, the solvent may be contained in an amount in a range of 70 to 90 wt. % or 75 to 80 wt. % based on 100 wt. % of the raw material composition. When a content of the solvent is within one of the above ranges, the visible-ray reflective polymer and inorganic particles as a solute may be effectively dispersed in the solvent. To the contrary, when the content of the solvent is smaller than the above range (e.g., less than 70 wt. %), it is difficult to form a uniform film due to insufficient dispersibility of the solute in the solvent. When the content of the solvent is higher than the above range (e.g., greater than 95 wt. %), a film formation process time is increased due to excessive solvent.

This step may further include heating the applied raw material composition after applying the raw material composition. The solvent in the raw material composition is evaporated under the heating to form the cured film containing the visible-ray reflective polymer and the pore-forming inorganic particles therein.

Specifically, after forming an applied film by applying the raw material composition, the applied film may be heated at a temperature in a range 40 to 80° C. for 2 to 5 hours. More specifically, this step may further include heating the applied film at a temperature in a range 50 to 70° C. for 3 to 5 hours after forming the applied film by applying the raw material composition. When the heating temperature is within one of the above ranges, there is an effect of forming a uniform cured film. To the contrary, when the temperature in the heating is lower than the above range (e.g., less than 40° C.), a problem occurs that the process time becomes excessively long. When the temperature exceeds the above range (e.g., greater than 80° C.), there may occur a problem that a uniform cured film cannot be formed. When a heating time duration is within one of the above ranges, there is an effect of forming a uniform cured film. To the contrary, when the heating time duration is smaller than the above range (e.g., less than 2 hours), a problem arises that the solvent that has not evaporated yet remains in the cured film. When the duration exceeds the above range (e.g., greater than 5 hours), a problem in that it is difficult to form a uniform cured film may occur.

### Step of Obtaining a Porous Base Layer

In this step, the pore-forming inorganic particles are removed from the cured film in an etching process to obtain the porous base layer in which pores derived from the pore-forming inorganic particles are formed.

For example, the formation of the pores may include etching the pore-forming inorganic particles using a weak acid solution to remove the pore-forming inorganic particles from the base layer. That is, the weak acid solution removes only the pore-forming inorganic particles, while the visible-ray reflective polymer is chemically stable against the weak acid solution, so that the visible-ray reflective polymer and the weak acid solution may not react with each other.

The weak acid solution may react with and remove the pore-forming inorganic particles such the pores are formed in the base layer. In this regard, the weak acid solution may be used without any particular limitation as long as it may react with and remove the inorganic particles. For example, the weak acid solution may be a fluorine-based solution. Specifically, the weak acid solution may include hydrofluoric acid. Specifically, the weak acid solution may be hydrofluoric acid.

### Step of Forming a Coating Layer

In this step, the coating layer including the infrared-ray emissive polymer is formed on one face of the porous base layer.

For example, in this step, a coating layer composition including the infrared-ray emissive polymer may be applied and cured.

Specifically, in this step, the coating layer may be formed by filling a mold with the coating layer composition including the infrared-ray emissive polymer, curing the composition, and then removing the mold. The infrared-ray emissive polymer is the same as that as described above with reference to the coating layer of the laminate. Further, the infrared-ray emissive polymer may include the same type of a polymer as that of the visible-ray reflective polymer.

Further, the coating layer composition may further include various additives in addition to the infrared-ray emissive polymer. In this regard, the additive may be used without any particular limitation as long as it may be added when preparing a polymer coating layer or a polymer film. Specifically, the coating layer composition may include an infrared-ray emissive polymer.

In this step, the coating layer composition may be applied and cured as described above. In this regard, the curing may be carried out at a temperature in a range of 50 to 90° C. or 60 to 80° C. for 1 to 4 hours, 2 to 3 hours, or 3 to 4 hours. When the curing temperature is within one of the above ranges, there is an effect that curing occurs appropriately. To the contrary, when the curing temperature is lower than the above range (e.g., less than 50° C.) or higher than the above range (e.g., greater than 90° C.), the curing does not occur appropriately, so that the coating layer may be not formed. When a curing time duration is within one of the above ranges, there is an effect that curing occurs appropriately. To the contrary, when the curing time duration is smaller than the above range (e.g., less than 1 hour), or when the curing time exceeds the above range (e.g., greater than 4 hours), curing does not occur appropriately, so that the coating layer may be not formed.

Hereinafter, the present disclosure is described in more detail based on examples. However, these examples are intended only for helping the understanding of the present disclosure, and the scope of the present disclosure is not limited to these examples in any sense.

### EXAMPLE

### Preparing Example 1. Preparing of Porous Base Layer

Poly(vinylidene fluoride-hexafluoropropylene) as a visible-ray reflective polymer (producer company: Arkema, product name: Kynar flex 2801, Mw: 500,000 g/mol) and SiO₂ as pore-forming inorganic particles (average particle diameter: 500 nm) were mixed with each other in a weight ratio of 1:2 to produce a mixture. Then, a raw material composition was prepared by mixing 20 parts by weight of the mixture with 80 parts by weight of dimethylformamide as a solvent. Then, the raw material composition was applied and dried at 60° C. for 4 hours to prepare a cured film having a thickness of 750 μm.

Thereafter, spherical pores were formed by etching and removing SiO₂ from the cured film using hydrofluoric acid to prepare a porous base layer (porosity: 60 area %, average pore diameter: 500 nm). In this regard, the porosity of the porous base layer is a value calculated as a percentage of the area of pores contained within 1 cm² of the SEM cross section, and the average pore diameter is an average value of the diameters of the pores contained within 1 cm² of the SEM cross section.

### Example 1. Preparing of Laminate

Poly(vinylidene fluoride-hexafluoropropylene) (producer company: Arkema, product name: Kynar flex 2801, Mw: 500,000 g/mol) as the infrared-ray emissive polymer was applied and dried at 60° C. for 4 hours. Thus, a coating layer of a thickness 150±50 μm was prepared. Acetone was sprayed on one face of the coating layer, and then the coating layer was laminated on the porous base layer of Preparation Example 1 and was dried to prepare a laminate for radiative cooling.

### Experimental Example 1. Measurement of Emissivity

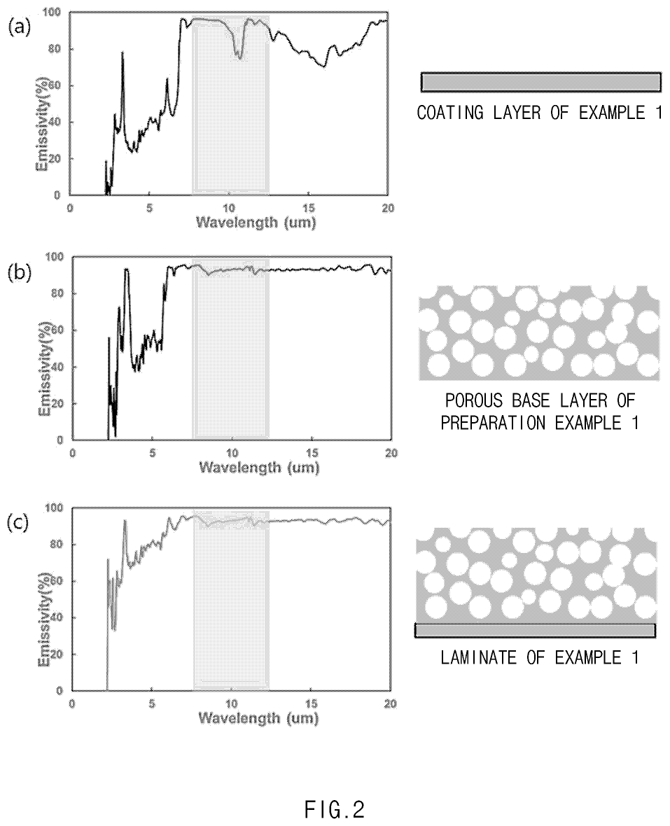

Emissivity of each of the porous base layer of Preparation Example 1, the coating layer of Example 1, and the laminate of Example 1 in a wavelength in a range of 200 nm to 20 μm was measured, and results are shown in FIG. 2.

As shown in FIG. 2, the laminate of Example 1 had excellent emissivity in a wavelength in a range of 700 nm to 20 μm, compared with the porous base layer of Preparation Example 1 and the coating layer of Example 1. In particular, the laminate of Example 1 was excellent in emissivity in a wavelength in a range of 8 to 12 μm as an atmospheric window, and thus had very excellent radiative cooling ability.

### Experimental Example 2. Measurement of Infrared-Ray Emissivity of Coating Layer

A coating layer was prepared in the same manner as that in Example 1, except that each of polyethylene terephthalate (PET) (producer company: SKC, product name: SG05), polycarbonate urethane (PCU) (producer company: BASF, product name: Elastollan 3090), polyvinyl chloride (PVC) (producer company: CLEANTEK, product name: E535-1), nylon (producer company: MISUMI Korea, product name: NCA), and polytetrafluoroethylene (PTFE, producer company: Sungho Sigma Co., Ltd., product name: F8043-1) was used as an infrared-ray emissive polymer.

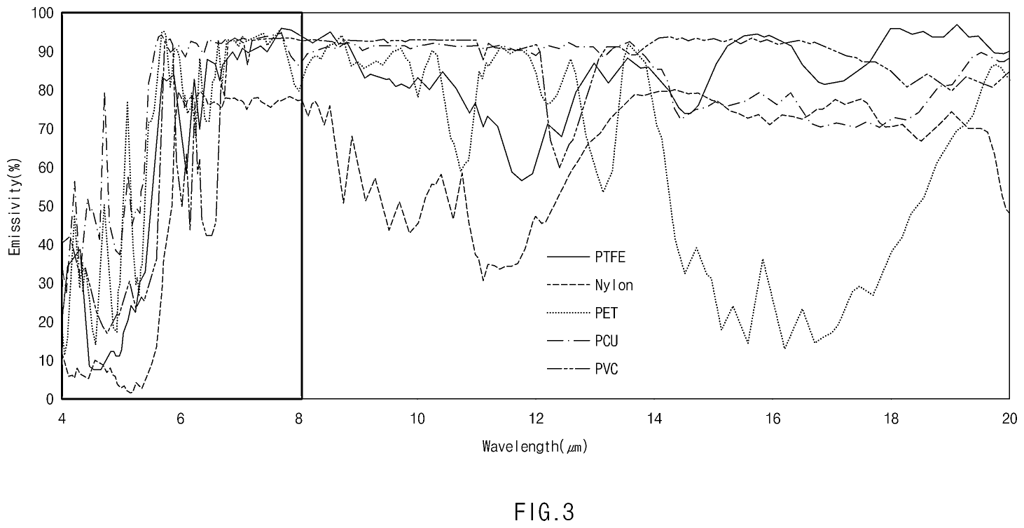

Thereafter, emissivity of each of the thus prepared coating layers in a wavelength in a range of 200 nm to 20 μm was measured. Results are shown in FIG. 3.

As shown in FIG. 3, the coating layer made of each of PTFE, nylon, PET, PCU and PVC had excellent emissivity of infrared-ray with a wavelength in a range of 400 to 800 nm. Thus, it may be expected that the laminate including the coating layer may have excellent radiative cooling efficiency.

The laminate for radiative cooling according to the present disclosure has excellent flexibility, excellent infrared-ray emission ability, and excellent ultraviolet-ray reflection ability, and thus very excellent radiative cooling ability. Further, the laminate for the radiative cooling has excellent radiative cooling ability as it has excellent emissivity in a wavelength in a range of 8 to 12 μm as an atmospheric window. Furthermore, the laminate for the radiative cooling has very good radiative cooling ability due to low absorption of heat energy via convection, and thus may be suitably used as a material in various fields such as vehicles that require a material with excellent radiative cooling ability.

Hereinabove, although the present disclosure has been described with reference to exemplary embodiments and the accompanying drawings, the present disclosure is not limited thereto, but may be variously modified and altered by those having ordinary skill in the art to which the present disclosure pertains without departing from the spirit and scope of the present disclosure.

What is claimed is:

1. A laminate for radiative cooling, the laminate comprising:
a porous base layer having a visible-ray reflective polymer with nano-sized pores formed in the visible-ray reflective polymer; and
a coating layer positioned on a face of the porous base layer, wherein the coating layer comprises an infrared-ray emissive polymer.

2. The laminate of claim 1, wherein the visible-ray reflective polymer comprises a fluorine-based polymer.

3. The laminate of claim 2, wherein the fluorine-based polymer comprises a copolymer having a hydrofluoroolefin (HFO)-derived repeating unit and a perfluoroolefin (PFO)-derived repeating unit.

4. The laminate of claim 3, wherein the fluorine-based polymer comprises poly(vinylidene fluoride-hexafluoropropylene).

5. The laminate of claim 1, wherein each pore of the pores of the porous base layer has an average diameter in a range of 80 nm to 600 nm, and
wherein the porous base layer has a porosity in a range of 50% to 80%.

6. The laminate of claim 1, wherein the infrared-ray emissive polymer comprises at least one polymer selected from a group consisting of a fluorine-based polymer, a urethane-based polymer, a vinyl-based polymer, an ester-based polymer, and an amide-based polymer.

7. The laminate of claim 6, wherein the infrared-ray emissive polymer comprises a copolymer having a hydrofluoroolefin (HFO)-derived repeating unit and a perfluoroolefin (PFO)-derived repeating unit.

8. The laminate of claim 1, wherein the porous base layer has an average thickness in a range of 600 μm to 900 μm, and
wherein the coating layer has an average thickness in a range of 50 μm to 500 μm.

9. The laminate of claim 1, wherein the laminate has reflectance of light of a wavelength of 200 nm to 400 nm in a range of 70% to 90%, and
wherein the laminate has reflectance of light of a wavelength of 400 nm to 800 nm in a range of 70% to 95%.

10. A radiative cooling element comprising:
a laminate having:
a porous base layer comprising a visible-ray reflective polymer with nano-sized pores formed in the visible-ray reflective polymer; and
a coating layer positioned on a face of the porous base layer, wherein the coating layer comprises an infrared-ray emissive polymer.

11. A vehicle comprising:
a radiative cooling element having a laminate,
wherein the laminate comprises:
a porous base layer having a visible-ray reflective polymer with nano-sized pores formed in the visible-ray reflective polymer; and
a coating layer positioned on a face of the porous base layer, wherein the coating layer comprises an infrared-ray emissive polymer.

12. A method for preparing a laminate for radiative cooling, the method comprising:
applying and curing a raw material composition containing a visible-ray reflective polymer and pore-forming inorganic particles to form a cured film;
etching and removing the pore-forming inorganic particles from the cured film to obtain a porous base layer in which pores derived from the pore-forming inorganic particles are formed; and
forming a coating layer comprising an infrared-ray emissive polymer on a face of the porous base layer.

13. The method of claim 12, wherein the visible-ray reflective polymer and the infrared-ray emissive polymer each comprises a fluorine-based polymer.

14. The method of claim 12, wherein the pore-forming inorganic particles comprise a compound or element selected from a group consisting of silicon dioxide (SiO₂), titanium dioxide (TiO₂), aluminum oxide (Al₂O₃), aluminum (Al), silicon nitride (Si₃N₄), and combinations thereof.

15. The method of claim 12, wherein the forming of the cured film comprises:
applying the raw material composition to form an applied film; and
heating the applied film at a temperature in a range of 40° C. to 80° C. for 2 to 5 hours.

16. The method of claim 12, wherein the forming of the pores comprises etching and removing the pore-forming inorganic particles using a weak acid solution.

17. The method of claim 12, wherein the forming of the coating layer comprises applying and curing a coating layer composition containing the infrared-ray emissive polymer.
